(19) United States
(12) Patent Application Publication
(10) Pub. No.: US 2024/0328175 A1
(43) Pub. Date: Oct. 3, 2024

(54) MULTI-TASKS ROBOTIC SYSTEM AND METHODS OF OPERATION

(71) Applicant: Amir ITAH, Hadera (IL)

(72) Inventor: Amir ITAH, Hadera (IL)

(21) Appl. No.: 18/290,458

(22) PCT Filed: May 12, 2022
(86) PCT No.: PCT/IL2022/050499

§ 371 Date: Nov. 14, 2023

Related U.S. Application Data
(60) Provisional application No. 63/188,494, filed on May 14, 2021.

(51) Int. Cl. E04G 1/24; E04G 1/34; G05D 1/229; G05D 1/646

(52) U.S. Cl. CPC E04G 1/24; E04G 1/34; G05D 1/229; G05D 1/646; E04G 2001/242

(57) ABSTRACT

This invention provides a multi-task robotic assistant and a method for autonomous or manual, mobile or non-mobile applications thereof. The robotic assistant comprises a scaffold, which is constructed of vertical poles and horizontal frames surrounding it, a load carrier carried by the scaffold, a manipulator carried on the load carrier, an end effector mounted on the manipulator for carrying out a selected task, sensors attached to the scaffold that return sensing information of the work environment of the robotic assistant, and a PMA (Process Manager Apparatus) that supports execution of a plurality of applications and tasks. The method of operation is done by creating one or more tasks, which are generated, controlled and executed by the PMA. The tasks may follow a 3D environment model and a preset ROI (Range Of Interest) or advance according to a user commands and information received from the sensors onsite. The tasks may be concatenated one to another, thus generating a complete mission for the robotic assistant to carry out.

### TECHNICAL FIELD

The present disclosure generally relates to systems and methods in robotics. More specifically the disclosure relates to systems and methods for autonomous or manually, mobile or non-mobile applications of a multi-task robotic apparatus. This system is easy to set and operate by almost anyone. This may include, for example, the easy to set and operate a mobile, autonomous robotic assistant, which is capable to handle different end-tools in different environments.

### BACKGROUND

There are currently several types of robotic systems. Most of these systems were developed and designed for specific tasks. Others can do a limited number of tasks. Some even have predefined tasks which they carry out autonomously in specific domains. Currently, these systems require a high skill operator and/or a high skill developer to set new tasks and/or have a dedicated design which limits the system capabilities. Several examples are: articulated robotic arm, humanoid like robotic system, lifting or hoist systems (articulated system or other), milling machines (CNC), 2D/3D printers, reception robots, autonomously coating robot, aerial device with an end tool, welding robots, medical scanners, painting robots for a car factory, security robots, etc.

Once installed and/or set, the current robotic systems suffer at least one or more of the following drawbacks: setting a new task requires a very high skill developer; a high skill operator is required; system design is very limited and unable to support new tasks; they cannot reach high places; heaviness; a large area or surface covered by the robot/machine (large footprint); insufficient accuracy and/or poor task results; difficult to deploy and/or move between locations; not configured to travel and maneuver in non-flat working areas; and presetting for carrying out missions in a pre-defined work plan. Thus, there is a need in the art for a product which is easy to use, capable of covering several tasks in various application domains, mobile in different environments, accurate with high end results, can be adapted to do a new task by a non-expert user and with limited or no additional development, set its own work plan and support and control operation of several systems in parallel.

### SUMMARY

The general concept model of the autonomous robotic assistant enables it to be configured for a wide range of missions and operations. It comprises the main essential capabilities for carrying out a variety of tasks that encompass structural flexibility, spatial orientation, adaptation to a variety of operations, control, learning and autonomous operation. Accordingly, in one aspect, the present invention provides an autonomous robotic assistant which is configured for multi-task applications in different domains. In still another aspect, the robotic assistant is configured for learning the execution of applications and operating autonomously. In still another aspect, the robotic assistant is configured to be operated by a non-expert operator.

In accordance with the general model and aspects of the invention, the general structure of the autonomous robotic assistant of the present invention comprises the following major components: a hoist or scaffold that is essentially a multi-joint foldable and expandable structure that can be adapted for any specific working zone and mission; a load carrier, which is an interface for a manipulator (for example, a robotic arm) or other load to be carried by the scaffold chassis; and an end effector, which is suitable for a particular work and is mounted on the manipulator/load; sensors for scanning and identifying the working zone to orient and localize the hoist/scaffold in the working space; and at least one computer and control unit for receiving and analyzing information from the sensors, mapping the working zone and directing the hoist/scaffold and manipulator and operating the end effector throughout the mission, controlling the spatial configuration and dimensions of the hoist/scaffold and the load and end effector if available; a User Interface (UI) and software which enables a non-expert operator to execute and generate applications for the system; and a mobile unit (aerial and/or land) which enables the robotic assistant to translate itself in the working space.

The foldable feature of the robotic assistant is based on a telescopic concept which is applied horizontally, longitudinally and/or perpendicularly. These folding capabilities enable the robotic assistant to adapt its chassis dimensions to meet requirements of different applications in different environments. The chassis also enables to support the load carrier, which is the base for carrying a manipulator with an end effector or a working device, to travel along its dimensions. Particularly, the chassis supports the load carrier to carry a load/manipulator to very high locations without turning over by adapting its base size and adjusting its base orientation to be aligned relative to gravity direction. A wider base also enables to increase the stability support in maximum allowed heights for the load carrier (with/without load) to reach. The flexibility of the frame base sizes of the robotic scaffold enables also to operate and carry loads in a limited space by reducing the frame base size and height. The capability to change the robotic scaffold base size enables to actually support and carry a load to high locations, because it compensates for the low weight of the robotic scaffold base. The capability to align the frame orientation with gravity direction enables preventing turnovers of the robotic assistant, support reaching elevated location without turning over. This capability also enables deploying and operating the robotic assistant on flat surfaces and/or unleveled surfaces and/or non-flat surfaces without turning over. This solution is unlike most current robots that comprise a very high weight in their base to prevent turning over when carrying loads to elevated locations. It is also different from most robotic systems that have difficulties in operating on unleveled surfaces and/or non-flat surfaces without the risk of turning over.

In general, the robotic scaffold comprises a modular design. This enables flexibility in the design of the system to support different applications in different domains of work.

By selecting the number of telescopic elements, the maximum available reach for the manipulator, namely the load on the load carrier, is defined and can be set according to the environment, in which the robotic scaffold needs to operate.

Also a mobility system can be selected to the robotic scaffold (aerial/terrestrial/none), which enables to define how the robotic scaffold translates itself inside the working area.

Having a frame enables to carry heavy weight loads. The maximum allowed loads weight is defined according to the final design of the telescopic chassis of the robotic scaffold. It will be understood by persons skilled in the relevant arts that a telescopic rod may be made of different materials, thickness, different number of elements that set the number of levels the rod can extend, different rods length etc. Setting selected values for these and such parameters will result in different maximum allowed weight loads that the robotic scaffold can carry.

Current aerial robotic options reach places with varying heights by hovering. However, they are unlikely to be stable enough to actually execute delicate tasks and get accurate results. This is because it is very challenging for an aerial device to execute most tasks while hovering and without missing or over shooting edges. In contrast, the scaffold of the disclosed robotic assistant of the present invention is configured to reach high places and maintain stability due to the folding chassis, which enables to perform different applications without overshooting at the edges of the working zone. This is otherwise not possible for a robotic system. Therefore, by having a frame (the robotic scaffold) that supports the load carrier, i.e. manipulator, at any moment and at any height, a large range of very fine and delicate applications can be carried out. These can be done without the need to compromise accuracy, final quality or safety.

An aerial device is required to constantly consume energy to keep steady in place. Having a frame to support the manipulator, as disclosed in the robotic scaffold of the present invention, reduces the total amount of energy consumed, because the frame by itself holds the manipulator in space without the need to consume energy to maintain its position. Therefore, the power consumption efficiency of the robotic scaffold is very high relative to aerial robotic devices.

In one embodiment, a User Interface (UI) enables a non-expert operator to set, teach, monitor, and execute autonomous tasks and applications for the disclosed robotic system. Unlike current robotic systems that require a high skill developer to set and/or operate and/or define a new task/application, the current disclosure comprises a Process Manager Apparatus (PMA), which only requires the user to select filters and working tools. All the rest is done autonomously by the PMA to execute the user's requested application including: reaching places in the working environment, generating path for the robotic system components to apply the application for all desired areas, monitor correct execution etc.

The integration of these components into a single unit with multi-dimension capabilities and functionalities generates a working device that emulates the flexibility of human work and adds advantages beyond it. In addition, it lends itself to autonomous and non-autonomous operation, remote or near control and adaptation of its structure and materials of which it is made to different loads and missions. The following describes in greater details particular embodiments and selected aspects of the robotic assistant of the present invention as well as best modes of making and operating it without departing from the scope and spirit of the invention as outlined above.

### BRIEF DESCRIPTION OF THE DRAWINGS

FIG. 1 illustrates one embodiment of robotic chassis in folded state.

FIG. 2 illustrates one embodiment of the robotic chassis in unfolded state.

FIG. 3 illustrates one embodiment of robotic scaffolds load carrier.

FIG. 4 illustrates one embodiment of robotic assistant.

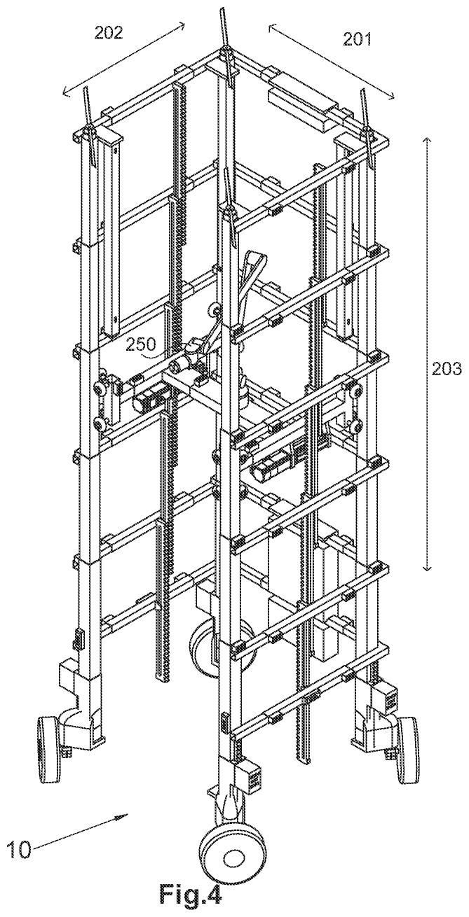

FIG. 5 shows a Task creation flow diagram of one embodiment of the robotic system.

FIG. 6 illustrates a particular example of flow of the autonomous robotic system.

FIG. 7 illustrates flow of the task 6.3 of ‘Robot localizes itself’ of the autonomous robot.

FIG. 8 illustrates flow for operating the end effector for a particular processing of a selected surface.

FIG. 9 shows an operation flow diagram of one embodiment of the robotic system.

### DETAILED DESCRIPTION OF THE DRAWINGS

In one embodiment, the present invention provides an autonomous mobile hoist/scaffold (robotic chassis) which is configured to translate itself with or without a load at different locations inside an environment, on top of almost any terrain and topography. Specifically, it is configured to carry and control a load. More specifically the load is primarily aimed to be a robotic system but the scaffold is not limited only for that. The robotic chassis is capable to translate the load according to gravity (up or down) and in varying different heights. The hoist frame can transform its shape to support different maximum available heights and is capable to change its base footprints to make the hoist stable and enable operation at different sizes of environment. Further, the scaffold is configured to always maintain itself normal to and parallel with gravity on complex and different types of terrain to prevent itself from turning over. It can support high weight loads relative to its own weight. Further, the mobile hoist is configured to be deployed adjacent to surfaces in which it is required to operate.

The operative component of the robotic device of the present invention comprises a manipulator, which is an apparatus that can translate its end in space inside a confined region. For example, the manipulator is selected from a Cartesian robot, an articulated arm robot, a joint-arm robot, cylindrical robot, a polar robot and any other configuration. The manipulator carries an end tool (end effector), which is attached to its end and interacts with the environment, specifically to carry out a particular task or mission. Examples of types of end effectors are grippers, process tools, sensors and tool changers. Particular grippers are a hand gripper, a magnetic gripper, a vacuum gripper and the like. Examples of process tools are a screwer tool, a cutting tool, e.g., laser cutting tool, drilling, tapping and milling, a vacuum tool, a dispensing system, e.g., air paint gun, atomizing paint bell, paint brush, glue dispensing module, dispensing syringe, a 3D printing tool, an inkjet tool, a sanding and finishing tool, a welding tool. Examples of sensors are accurate force/torque sensors, a computer vision module, e.g., ultrasonic, 2d and 3d cameras, scanners, a dermatoscope tool. Other end effectors which may be mounted on the manipulator are a tool changer, a fruit-picker, a sawing tool and any other end effector that may be contemplated within the scope of the present invention. The control, supervision and operation of the robotic device of the present invention is done with an autonomous surface extraction and path planning apparatus, also termed herein, Process Manager Apparatus (PMA), for robotic systems. The PMA generates instructions for the robotic system how to process an environment. The instructions are calculated based on parameters that enable to filter the environment and according to the end effector parameters which are selected for the process. The operator sets values for these parameters and/or selects an example of the required surface to be processed from memory or live from system sensors. These are used to filter the specific surfaces from the environment, which will be processed. In addition, the operator also selects which end effector to use. These settings define a task, where concatenation of one task or more results in an application, where an application can be constructed in almost every domain. Examples of such applications, which may be combined from a plurality of more basic tasks are as follows: scanning the environment and getting a 3D model of a region; autonomously grinding of a surface; scanning a human body and detecting human moles (all are different applications in different domains which all can be set and executed by the disclosed apparatus).

In a further example, the robotic device of the invention comprises an Ensemble Manager, which is a collective manager that can manages several PMAs. The Ensemble Manager has a channel to communicate with every Process Manager Apparatus, for example to receive data from each PMA (each robot) and send operation instructions to selected PMA of operating robotic devices. Communication between the Ensemble Manager and the Process Managers can be wire or wireless, so the communication channel between them can be wire or wireless. For example: several Robotic assistants are deployed in site and each one sends part of the 3D environment for the Ensemble Manager. The Ensemble Manager (EM) can align and assemble each portion of the model to a single model that later can be used to guide and mange each specific robot to dedicate a region for operation and/or specific task. Another example is to synchronize the operation of the robots for each to perform a different task.

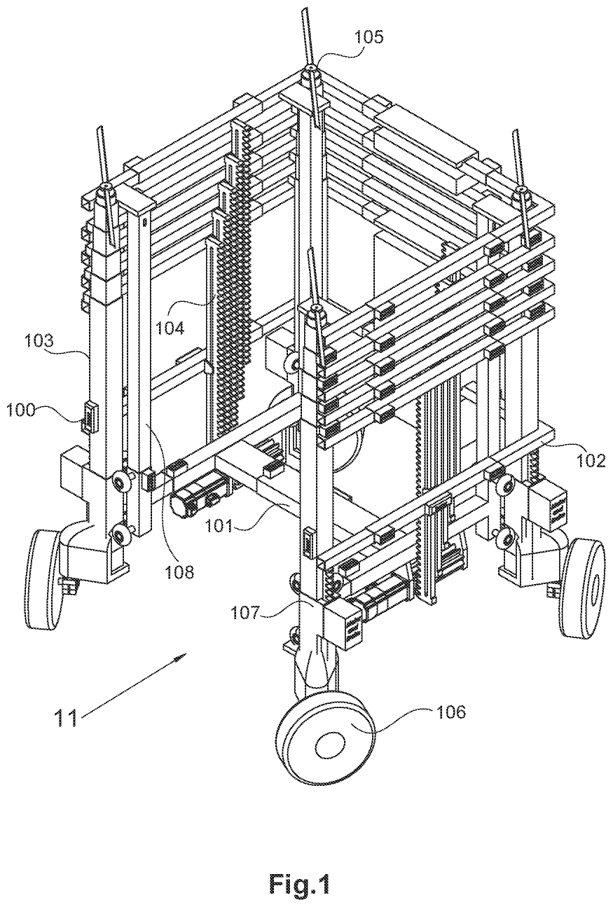

FIG. 1 illustrates the robotic chassis 11 of the robotic assistant 10 in its folded state. The main parts that form the scaffold comprise a chassis frame support 102, telescopic poles 103, a load carrier 101, gravity leveler 107, and optional land mobility units 106 that may connect/attach to the lower ends of the poles 103, and optional aerial mobility units 105 that may connect/attach to the upper ends of the poles 103 at the upper end of the chassis frame. The load carrier 101 is attached to the chassis and is movable along the telescopic poles 103, namely inside the space enclosed by the frame, thus allowing an operative component to engage with a working plane at any required relative level. In an alternative embodiment, it will be understood by persons skilled in the relevant arts that the load carrier can be fixed to the top of the folding scaffold. The robotic assistant 10 can move in any working zone, limited only by its attached mobility unit. Particularly, the folded state increases the stability of the robotic assistant 10 while moving. In its movement in the folded state, the robotic assistant can easily be translated between sites and locations, keeping the scaffold and all systems mounted on it in a compacted and secure form and occupying a smaller space when stored. It is also understood that the robotic assistant is modular and can be disassembled and assembled onsite for trans-locating it from one site to another. The folding of the telescopic poles 103 of the scaffold enables to control its height according to different parameters, for example the load on the robotic device, relative level of the working zone or surface, the torque applied by the robotic device, the physical dimensions of a working element in the working zone etc. The robotic assistant also deploys its scaffold according to different attributes that are related to the working zone such as the zone dimensions, space, volume and geographic borders relative to the dimensions and volume of the scaffold, the zone topography, its free space relative to surrounding objects and other zones and reasonable safety margins for operation of robotic assistant. The telescopic poles 103 are built from a plurality of parts, which are engaged together in a consecutive order, where every part can be folded and unfolded separately from its neighbor parts, autonomously or manually. The chassis frame 102, which is attached to the poles around their outer surfaces, is also constructed from a plurality of parts in telescopic type of engagement between them. The chassis parts may also fold and unfold separately from each other and autonomously or manually. For independent folding and unfolding of the parts one relative to the other, every part of the poles has a braking and/or locking mechanism, which enables holding the telescopic poles in a desired length and maintain and carry them in stable position. Correspondingly, the folding and unfolding of the poles is done in a controlled way, where every stage of folding and unfolding is done independently and separately from consecutive stages and in safe and secure way. Folding and unfolding of the poles retracts or extends their total length and respectively the enclosed volume of the robotic device and its ability to work in any dimensions of a working zone. The robotic scaffold can autonomously change its base footprint by moving only part of the telescopic stands in horizontal/depth directions. Another available option is to manually set the robotic scaffold footprint. The scaffold may also have a base that separately expands and contracts from the vertical part of the scaffold. Such base may also be constructed of telescopically connected parts, which by themselves may translate independently from each other. As a result, the footprint of the scaffold is essentially determined by this base as it expands and contracts horizontally relative to the vertical part of the scaffold and the working zone.

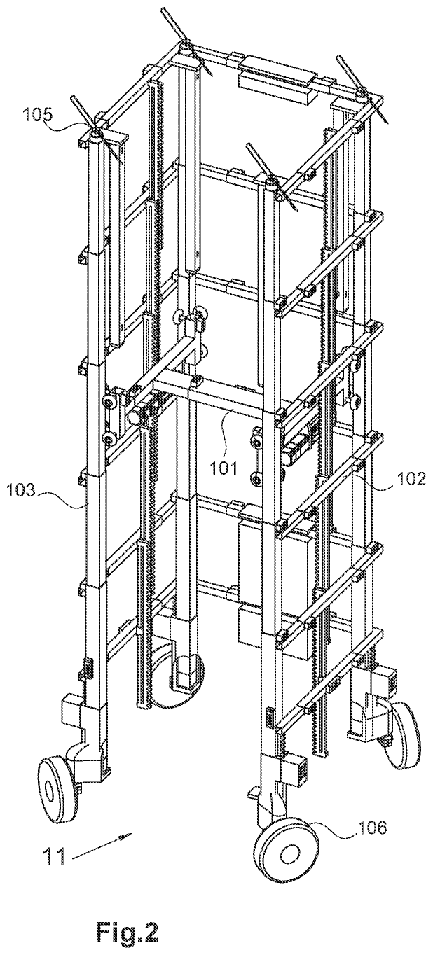

FIG. 2 illustrates the robotic chassis 11 in unfolded or deployed state. The chassis is in expanded state, where its horizontal frames 102 are distanced from each other at selected gaps according to their relative position on the poles 103. Particularly, both the poles 103 and frames 102 are expandable and retractable, vertically and horizontally, respectively, with similar or different mechanisms. The poles 103 maintain their fixed position as they retract and expand with a lock and release mechanism such as pins or any lock and release mechanism between every two engaged parts of the poles. The frames of the chassis 102 move with the poles 103 in the poles direction, but may also expand and retract in the x-y plane similarly to the poles and perpendicular to the poles direction. Such frames may also be configured in a telescope mechanism and fix their position with any lock and release mechanism 1021, which is suitable to the design of the scaffold and objectives of the robotic assistant. Thus the scaffold is provided with the advantage to adjust its dimensions independently of each other in a three dimensional space, thereby expanding its flexibility to adapt to a larger range of missions and tasks.

The load carrier 101 can travel autonomously and be shifted up or down by using a folding rack pinion concept or other methods. Non-limiting examples that apply such a concept are a pulley system, leading screws, a propeller, a linear magnetic force module etc. In these above examples it is an option that the load carrier might be fixed to the top of the telescopic units 103, shifted up or down when expanding/contracting the telescopic module 103. The rack pinion (and all the other non-limited examples above to shift the load carrier up or down) can stop and hold in place at any height, even when the system is turned off or no power is available, by having its own brake and/or locking components. The load carrier 101 can also be extended to compensate changes in the chassis frame and poles of the scaffold. Namely, when the chassis frame and poles expand or contract in any, part or all of the three axes in one or more dimensions of a working zone, the load carrier 101 adjusts itself to the changing dimensions of the chassis and poles, thus enabling the load carrier to maintain the manipulator 250 installed on it and the tools and add-ons, which are mounted on the manipulator 250. Adjustment of the load carrier 101 can be done automatically and concerted with the change of dimensions of the scaffold parts. Alternatively, the dimensions of the load carrier 101 can be adjusted manually by an operator. In cases where only the robotic chassis base extends and adjusts its dimensions, the scaffold itself does not extend, and therefore the load carrier is not required to compensate for any changes in the horizontal x-y plane.

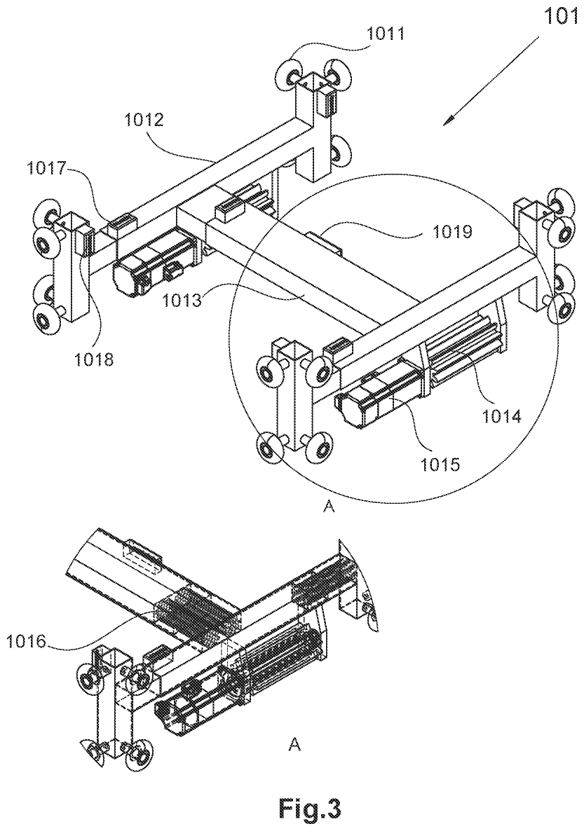

FIG. 3 illustrates a zoom-in and internal views of a particular configuration of load carrier 101 applied to the folding rack pinion 104 concept, which is illustrated in the embodiment where the load carrier is not fixed to the top of the telescopic units 103. It will be understood by persons skilled in the relevant arts that the same concept of load carrier can be implemented in different ways with similar results, specifically when the vertical shift mechanism of the robotic chassis 11 is different from a folding rack pinion. In the specific embodiment of load carrier 101, illustrated in FIG. 3, two horizontally positioned telescopic bars 1012 parallel each other are connected together with a third bar 1013 that is positioned orthogonally to both of them. Each one of the parallel bars 1012 terminates with perpendicularly aligned bars relative to them, where each vertical bar carries carriage slides 1011 for travelling up and down the scaffold. The parallel and perpendicular bars comprise a control and safety mechanism in the form of a brake/lock 1017 to control the expansion and contraction of the bars and secure their position in a safe manner. A motor 1015 is used to activate the expansion and contraction of the poles. The zoom-in view shows a cut of the load carrier in FIG. 3 and exposes the internal space of horizontal and vertical bars with their contraction and expansion mechanism 1016. Specifically, this mechanism 1016 comprises springs that occupy the internal space of the bars and contract and expand with the contraction and expansion of the bars. The control and safety mechanism of the brakes 1017 locks the bars at a point between their edges and fixes them in a corresponding length. The horizontal and vertical bars set the dimensions of the load carrier, specifically its width and length. A motor (with brake) 1015 rotates pinion 1014, which enables the carriage to travel vertically on a chassis frame (along telescopic poles 103) and also to lock the load carrier position. The rotation of the pinion motor translates to translational expansion or contraction of the telescopic poles 103.

As mentioned, the number of telescopic elements of the robotic scaffold can vary so that changing the dimensions of the scaffold, including height, width and length, by adding or subtracting telescopic elements changes the dimensions of the scaffold. Particularly, adding or subtracting telescopic elements increases or decreases the maximal or minimal height of the scaffold, respectively. Particularly, the maximum size of the base and corresponding height can be set by setting the maximal number of its telescopic elements. The telescopic elements of the robotic scaffold themselves may be provided in different lengths, thereby providing an additional variable for changing the dimensions of the scaffold and chassis frame in the scaffold folded and unfolded states.

Folding and unfolding the telescopic poles 103 can be done in different ways that depend also on the linear shift mechanism, as described previously, and also whether the load carrier 101 is fixed or not. In an embodiment shown in FIG. 1, where folding rack 104 and pinion 1014 concept is demonstrated, a pole 108 is attached to the upper telescopic pole of the robotic chassis 11. This pole is designed in such a way that the load carrier 101, illustrated in FIG. 3, can attach/detach to pole 108 using locking mechanism 1018. If the load carrier is not in an attached state, it can slide down the pole 108. To expand the telescopic poles 103 the load carrier 101 attaches to pole 108 by traveling up, and once in position it shifts to lock state of locking mechanism 1018. Later, the first lower locking mechanism of the telescopic poles 103 from below is unlocked. When the load carrier travels up by rotating the pinion 1014 along the rack 104 the lower pole expands and all the other poles shift up. Once the lower pole is in a desired height, its lock mechanism is activated and locks the pole in place to a fixed position. Later, the next pole locking mechanism is released. Again the load carrier 101 travels up and expands the next pole. This process repeats till all the poles are extracted or a desired height is reached. The position of the load carrier 101 can be extracted both from the navigation sensors 1019 and/or from the feedback of the motor that rotates the pinion. Once done, the load carrier detaches from pole 108 and is able to travel along the entire length of the expanded telescopic poles 103. Other non-limiting examples of folding-unfolding of the telescopic robotic chassis can be using lead screws for each telescopic pole level, a rack pinion for each level of the telescopic concept, or a pulley system that expands the entire scaffold. The load carrier can be fixed on top or travel along the chassis for example with the rack pinion or by using the manipulator 250 attached to the load carrier 101 to push each telescopic level to fold/unfold the scaffold and later to travel along the telescopic poles 103 using one of the suggested examples or other similar ways. A person skilled in the relevant arts might think of other ways to implement different engineering solution to expand/contract the chassis and/or other ways to translate the load carrier along the frame with a similar outcome.

The low weight of the robotic scaffold makes it feasible to be attached to an aerial hovering unit to enable the system to hover and travel between locations in the air. Thus, for aerial or above-ground missions an aerial rotor and motor 105 may be provided to the robotic device. As shown in FIG. 1, the motor 105 is attached to the top ends of the scaffold to lift it up in the air for traveling above-ground in a non-flat topography of a working zone. Alternatively, the aerial hovering capabilities can be imparted to the robotic assistant by integrating an aerial unit into the system or by integrating an off-the-shelf aerial vehicle. After identifying a suitable location on the ground, the robotic assistant lowers back to the ground and leveled to continue or complete its task. In any case, once an aerial unit is assembled with the system, it can be used to fold and unfold the system and constantly maintain the scaffold orientation vertical relative to gravity direction, which for example prevents the scaffold form turning over. For example, lift-off of the robotic assistant while level brakes are released will result with unfolding of the frame upwards. Thus, the robotic scaffold is configured to support and translate loads in space across different terrains in different environments. More specifically the robotic scaffold is designed to support a manipulator to process a plurality of different applications in different working zones. Therefore, it is designed to be low weight, reach high locations, stable and modular. Optionally, the scaffold is configured to hover inside a working zone in order to skip obstacles and translate itself in space. Further, it is configured to be deployed in complex zones, for example on top of roofs or up a staircase. At any point, the scaffold can be turned off and stay fixed in its last position by engaging all locking mechanisms of both telescopic poles and of the manipulator axes/joints/others and of the end effector units. This is advantageous because it maintains its safety and power efficiency during operation. The autonomous operation of the robotic device keeps it aligned in the direction of gravity and prevents it from losing its orientation and balance, such as turning over, to the side or upside down.

A set of sensors 100 is attached to the scaffold, including poles and chassis frame, and distributed at different locations on them for scanning and collecting information on the working zone and enabling the device 100 to identify its location in a multi-dimensional surroundings. In general, the robotic scaffold comprises sensors and feedback. Generally, and without limitations, the sensors 100 are divided into three groups: 1) environment sensors; 2) feedback sensors; and 3) positioning sensors.

The environment sensors are sensors which are configured to return sensing information of the environment including its position relative to the robotic chassis in space. For example, a three dimensions camera such as LIDAR, stereo cameras, structure lights, Time Of Flight cameras and other devices return the surface shape of the environment. A thermal camera is another example that senses temperature levels in a three dimension space and corresponding coordinates relative to the robotic assistant. A third example is a proximity sensor. Feedback sensors are sensors that return information relative to themselves. Particular examples are a motor encoder, a pressure feedback, a current level sensor and a voltage level sensor. Positioning sensors are sensors that locate the robotic assistant in space or the world. For example, Global Positioning Sensors (GPS), local positioning sensors that return their position and orientation relative to gravity (gyro, accelerometers), tracking cameras, etc.

For the robotic scaffold to support different applications, a synergy between all its components is required. The robotic scaffold indeed comprises this synergy by having sensors that sense the position and orientation of the robotic assistant and enable it to monitor the environment and receive feedback about its status both relative to itself and the environment. When deploying the robotic assistant, the sensors provide it a feedback from the environment in three dimensions. These enable the system to be familiar with the expected surface and obstacles in space. In addition, having self-positioning sensors enables to constantly monitor the system position in space. Therefore, it can calculate and determine its next move before executing it while preventing collisions and preparing to adjust the gravity compensation to prevent turnovers. When extending and transforming the system in vertical position, the feedback from the orientation sensor is used to calculate the correct gravity compensation commands and values in every moment. This is done continuously while extending the assistant to maintain itself normal in correct gravity direction and prevent turnovers. Having feedbacks about the system orientation and deployment status enables to simulate the current frame model in real-time. Therefore, it enables to calculate the center of mass and determine the correct minimum base size to support the required vertical extension for any particular application that the robotic assistant carries out. Other uses of the system orientation and current model in real time include helping to generate a trajectory (for every component of the robot, including the manipulator and end effector), in which any collision between the robotic system and the environment is prevented. A person skilled in the relevant art can find that having a model of the system enables other features and advantages.

In one embodiment, a gravity leveler 107 is illustrated in FIG. 1. Each telescopic pole 103 of the scaffold has an extension part at its bottom, which can be expanded and retracted independently of the pole's expansion and retraction. This results in control over the orientation of the entire scaffold. The expansion and retraction mechanism can be implemented by using a rack pinion concept, extra telescopic level or other concepts such as a piston (hydraulic, magnetic), or any other mechanism for leveling the scaffold relative to a reference gravity plane.

The scaffold has both a gravity leveler mechanism to control its own orientation relative to gravity and also an orientation sensor that constantly sends feedback on the actual scaffold orientation. When an aerial device is attached to the scaffold, the telescopic poles 103 of the scaffold are used as gravity levelers. Each telescopic pole can have a total length that is different from the lengths of the other poles, which enables controlling the orientation of the scaffold.

The system for operating the robotic assistant is configured to support the execution of a plurality of applications/tasks. To this end, it comprises a user interface (UI) apparatus, referred herein as PMA (Process Manager Apparatus). This PMA is configured to be used as an application manager, which is installed in any existing and independent robotic system, or it may be an integral part of a robotic system. Accordingly, it is configured to be used as an upgrade kit for a robotic system and convert the assistant system to an autonomous robotic system, enabling it to learn and execute a plurality of applications in different fields of operation.

The PMA is an apparatus that manages the system and makes it an autonomous robotic system. More specifically, it is configured to generate an autonomous application in different domains. By filtering the environment and taking the attached end tool parameters into account, the PMA autonomously generates commands to the robotic assistant that result in an autonomous specific application. The PMA is, therefore, configured to communicate with the robotic assistant 10 and operate, control and monitor it. Accordingly, it generates and supervises the autonomous applications of the robotic system. In general, the PMA controls, communicates and monitors any device which is part of the robotic system, including loads and end effectors that may be assembled with and connected to the robotic assistant.

For proper operation, the PMA comprises a UI (User Interface), which is required to operate the robotic assistant. This UI mainly comprises any or all of a GUI (Graphical User Interface), control panels, voice commands, gestures sensitive screen, a keyboard, a mouse, joysticks and/or similar devices. Operating the assistant comprises setting the system, monitoring the status of the assistant, starting, stopping or pausing the assistant operation and all other features that an operator needs in order to operate a robotic system. The GUI interface can be operated directly on a dedicated device, which is part of the robotic system. Alternatively, the GUI may be a standalone interface that is configured to remotely communicate with the assistant. This may include for example a computer with a monitor, a tablet device, a cellular device, a cellular smartphone and other similar devices with means for wire or wireless communication with the assistant and control means to operate it.

In general, the PMA comprises a power unit, software (SW) algorithms (Algos) for operating the robotic assistant, at least one central processing unit (CPU), at least one control unit (Controller) that can control inputs/outputs, motor types, encoders, brake and similar parameters of the assistant, at least one sensor which is configured to sense the environment of the assistant, an interface with the robot devices, e.g., motors, sensors, other sensors and communication devices. Non-limiting examples of sensors are one or more of laser range finders, laser scanners, lidar, cameras, optical scanners, ultrasonic range finders, radar, global positioning system (GPS), WiFi, cell tower locationing elements, Bluetooth based location sensors, thermal sensors, tracking cameras and the like. In one particular embodiment, the PMA requires supplementary devices to operate and control the robotic system. For example and without limitations such devices comprise drivers, motors, which may be of different types such as electric or hydraulic motors, brakes, interfaces, valves and the like.

The PMA can be used as an application manager for any newly installed robotic system. In another alternative, it can also be used as an upgrade kit for any particular robotic system. When used as an upgrade kit, dedicated interfaces to the robotic system may be used to enable the PMA to communicate, control and mange any component of the robotic system. The robotic system interfaces are connected to the PMA. Such connection enables the PMA to obtain any data from the sensors on the robotic assistant and control all the features of the robotic system. For example and without limitations, the PMA may take control of moving the robotic system to position, get the status of every motor that operates in the robotic assistant, encoders feedback, sensors feedback and the robotic system allowed region of operation. Further, the PMA may obtain values of other parameters, which relate to the ongoing operation of the assistant in real-time in any working zone.

In particular, the PMA is configured to entirely control, operate and manage the chassis frame and poles of the scaffold of the robotic assistant 10. For example, it is configured to obtain the readings of all sensors from the chassis, control all the motors that operate the expansion and retraction of the chassis poles of the scaffold and status of the brakes. Further, the PMA may also be configured to obtain data related to self-location of the chassis in any particular environment, control the carriage hoist height, keep the scaffold normal and parallel with gravity direction, change maximum height allowed by folding and unfolding the chassis, fold and unfold the robotic chassis base to increase stability and prevent the system from turning over.

In case that a dedicated gravity level unit is attached at the bottom of the scaffold, keeping the scaffold normal with gravity is done by receiving the current readings from the orientation sensors, processing them, calculating the correct expansion/retraction of the gravity leveler pole/piston and sending commands to actually change its expansion/retraction according to the calculated value. This enables to keep the scaffold normal relative to a reference gravity plane and align it with gravity direction to prevent it from turning over.

If an aerial mobility unit is attached, no extra gravity leveler module is needed and the lowest parts of the scaffold poles 103 are used as part of the gravity leveler mechanism. The aerial unit hovers and the lowest part of each telescopic pole is unlocked. Then, the aerial unit keeps hovering in order to level itself according to the orientation sensor and be aligned with gravity direction. The lowest parts of the poles keep touching the ground due to gravitation and are self-extended to the correct length, which keeps the scaffold aligned with gravity direction. Once the scaffold is leveled, the pole is relocked and the aerial unit can turn off.

When the system hovers to a different location, the process repeats itself in the landing stage in that location.

Leveling the scaffold orientation can be done continuously or on demand. Once triggered, it is done autonomously.

In general, the system has two modes of operation, manual and autonomous. Manual mode is a state where each component of the robot can be operated manually by setting direct commands or by manually setting a sequence of commands to the robot. In this state, any information from any sensor or another component with feedback can be seen by the operator. The information from the feedbacks can also be used as a condition or reference for a sequence of commands, which will be set manually by the user.

Autonomous mode is a state where the PMA operates the robotic assistant by generating commands for the robotic assistant autonomously without or with little operator intervention. The commands can be for example: move to position, wait till sensor trigger threshold, expand scaffold, trigger relay, verify an object is seen, . . . etc. This list of commands can control all components of the robotic system.

The PMA software algorithm comprises also and without limitation filter components referred to as Filter Blocks and a surface path generator referred as Path Generator.

A Filter Block is a software (SW) block, which is used to filter the environment and extract only data that pass the filter. The filtered data comprise the environment model for a process referred to as Filtered Surface. Filter Blocks can be added to the system. A Filter Block can be a simple ‘if statement’ or complex algorithms including and without limitations artificial intelligence, edge detections, object recognition, pattern recognition, etc. For example, a color filter that checks if the environment data (3D model) meets the desired color range or not, filters the information that meets the selected range and removes the data outside the limits of that range. Filter Blocks can be shared by a community and between PMAs or created by the operator.

A Path Generator gets Filtered Surface and end tool parameters, and later generates a trajectory that crosses the entire surface.

The PMA requires to get the settings to be able to sense and process correctly the environment and generate autonomously and correctly the sequence of commands for the robot to process the environment. These settings are encapsulated in the PMA and referred to as Task. Several Tasks are encapsulated inside an application referred here as App.

A Task is a set of settings and constraints which configure: Filter Blocks and Filter Blocks sequence (to extract Filtered Surface, the filtered surface for operation from the environment 3D model) and set edges and ROI (Region Of Interest) conditions for the robotic assistant 10 and select/set end effector parameters for the process.

A Task can be stored and loaded from memory. Alternatively, a Task can be set by the operator.

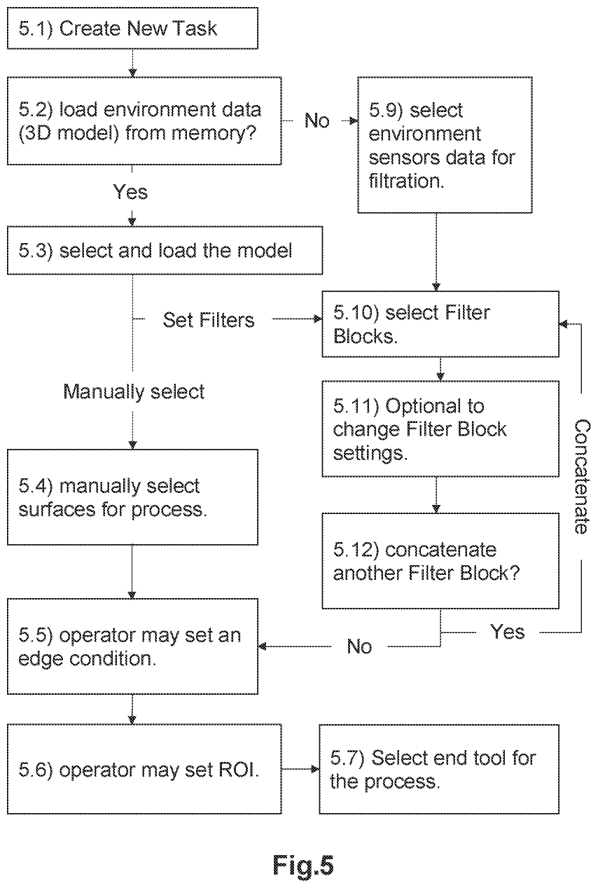

FIG. 5 illustrates how to create a new task. Generally there are several flows to create a new task: 5.1), 5.2), 5.3), 5.4), 5.5), 5.6), 5.7), or 5.1), 5.2), 5.3), 5.10), 5.11), 5.12), 5.5), 5.6), 5.7), or 5.1), 5.2), 5.9), 5.10), 5.11), 5.12), 5.5), 5.6), 5.7).

Tasks 5.10), 5.11), 5.12) can be repeated in this sequence as many as Filter Blocks the operator would like to apply. The following details the actions taken for each task:

5.1) In the UI, the operator selects to create a new Task.

5.2) The robotic assistant can operate repeatedly at the same place. Therefore, there is an option to load from memory a stored environment model from previous operations or from 3D computer aid design (CAD) model, thus preventing unnecessary scans.

5.3) The operator selects which model to load from memory. A memory for example can be local on the PMA or in a remote station, for example: cloud service, disk on key, another PMA, etc.

5.4) Once the model is loaded, the PMA can visualize it for the operator using the UI.

From the UI, the operator can select specific places and surfaces for the robotic system to reach and process.

5.5) Edge conditions can be set to trigger an end of a surface. For example: color variations, gap between objects. Such conditions have a concept similar to Filter Block, but for specific purpose for this step.

5.6) An operator may set a region of interest. This region limits the range that the Robotic system can operate in. Essentially it trims the environment data for processing by the system, although it does not trim the data for navigation. For example, if the Environment data is a box shape with the dimensions of 10 m×10 m×3 m and the lower left corner at the origin of axes (0 m,0 m,0 m) and the ROI is limited to a smaller box of 2 m×2 m×1.5 m at the origin, then the environment allowed for processing will be only this smaller box. So, for example, for a spray coating application of the box sides, only part of two sides will be coated only to half of its height (each side 2 m×1.5 m).

5.7) The operator is required to set which end tool the Robotic system will use. Each tool has its own parameters for operation, which are required to generate the correct path for the robotic system. The End effector has a surface projection pattern. This projection pattern is related both to the end effector projection pattern relative to a flat surface and the orientation and distance between the end effector and the surface and the surface shape. For example, a spray end tool, located at a specific distance from and normal to a flat surface, generates a pattern on the surface. This pattern can be round, oval or any other shape. Changing the distance and/or the orientation results in a different spray projection on the surface. This actual pattern can be calculated in advance, taking into account its actual expected projection on the surface for processing. The end tool projection parameters enable for the Path Generator to calculate and estimate in advance the expected portion of the area to be processed for every point that the end tool (End Effector) interacts with at the surface.

5.9) In cases where no 3D model is loaded, the operator is required to select to which sensors data to apply the Filter Block that will be selected.

5.10) The operator selects Filter Block to apply for a task. For example: for a range filter—all the data inside this range remain; for a color filter-all the data that meet the color range remain.

5.11) Changing the range parameters to filter with a selected Filter Block that correctly filters the environment. This can be done by manually changing the range parameters or sampling the environment and extracting its parameters. The operator gets a snapshot of the surface using the selected sensor data. Then the filter block gets the parameters range in the sample relevant for the selected Filter Block. The calculated parameters set the Filter Block range parameters. For example, the operator snaps part of a surface and assumes that the selected filter is the surface normal vector. The filter calculates the sample normal and uses it as the Filter Block reference. Then only the data with a similar surface normal remains. On the other hand, the user can just manually write a desired surface normal.

5.12) If another filter is required to apply on the filtered data, the operator can concatenate another Filter Block. For example the user sets Filter Block 1 and concatenates Filter Block 2. First Filter Block 1 is used to filter the data and then the filtered data pass through Filter Block 2 and are filtered again.

Tasks settings are inputs for the Path Generator that generates trajectories and other commands such as controlling relays, send wait commands till time passes or sensing something etc. These commands result in the robot to actually do an autonomous process. The Path Generator generates a trajectory so the end tool passes along every surface in the environment and the whole surface that should be processed. However, each end tool does not reflect a single point but has a projection shape that actually interacts with the surface. For example, if the Filtered Surface is a 1×1 m² flat surface to be grinded, the end tool should travel through every point of the surface and grind it. Assuming that the grinder has a width of 250 mm and a height of 250 mm, the path generator can build a trajectory that starts at a lower left corner and offsets the grinder upwards by half the height (125 mm) and half the width to the right (125 mm) and up to the surface maximum height minus half of the end tool height (1 meter-125 mm). This path will grind part of the Surface (250 mm width×1 meter height). Next the path generator requires determining what length to travel to the right to go down and continue with the grinding process. If the movement to the right is greater relative to the grinder width then part of the surface will not be processed. If this length is exactly the grinder width, then the entire surface will be processed without any overlaps. If it is smaller relative to the grinder width, then part of the surface will be processed again as an overlapped region.

In addition, the Path Generator can monitor sensing units that can be part of the end effector. For example, the end tool can comprise a distance sensor that measures the distance from the surface. The Path Generator can keep sending commands to the robotic system to maintain and keep the end effector at constant distance along the process. Another example is a pressure sensor that monitors the pressure that the end effector applies on a surface. The Path Manager can keep sending commands to the end effector to maintain a constant pressure against the surface by sending commands to come near or far from the surface.

Generally the Path Generator gets Task data and generates the actual commands to the robot. It can also update the commands in real-time operation of the system.

End tool, namely end effector, settings can be added to or removed from the PMA. End effectors generally contain setting parameters that are relevant to the generation of a process.

Defining end effectors for the PMA is done according to different attributes such as: projection shape of the end tool (as extracted from the surface depending on distance), required overlap, offset of the end tool relative to the manipulator edge, feedback from sensor that can be part of the end tool, angular orientation of the end tool relative to gravity, etc. Not all parameters are set for every end effector, but the relevant ones. The end tool sensors mainly require correcting motion during actual operation, but are not limited for this purpose only. If the end tool does not have a sensor, it remains blank and will be ignored. For example, if the end tool does not include pressure sensors, the Path Generator will ignore pressure issues assuming the pressures is always correct during operation.

The operator creates a new App by concatenating several tasks. For example, a first task can be without any filters or defining edges, setting the range of ROI but without including any end effectors. This task results in an environment scan till the ROI is entirely scanned, producing a 3D model of the requested ROI. Next task will be coating, for example by selecting a spray end tool for coating only the white areas in a specific region, for example by setting a white color filter. For such an App, the robot scans the environment. Then, the same environment model if filtered by the Filter Block to extract white locations. As a result, the Path Generator generates trajectories for the robotic assistant to travel only towards white surfaces and coat every one of them.

For an autonomous mode of operation, the system requires a 3D model that can be loaded from a memory, e.g., from a previous scan or a 3D CAD model, or acquired by scanning the environment.

The robotic assistant has 3D sensors, localization sensors and feedback from its own components, which enables to sense the environment and localize the data relative to the position and orientation it acquires. As a result, the sensing data can be assembled to a 3D model. The robotic assistant is also configured to travel in space to scan and acquire improved data or missing areas of the environment. Sensing the environment enables the robot to prevent collisions with obstacles while traveling and operating, particularly when scanning and constructing the environment 3D model.

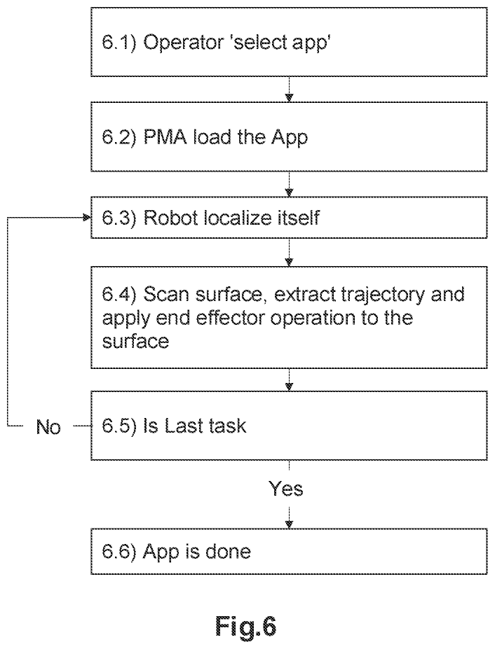

FIG. 6 illustrates a general flow scheme for the autonomous operation of the disclosed robotic system.

The flow essentially comprises the following sequence of tasks: 6.1), 6.2), 6.3), 6.4), 6.5), 6.6).

The following describes the tasks in the general scheme in more detail:

6.1) The operator selects an App for execution.

6.2) The PMA loads the selected App.

6.3) The robot localizes itself in the 3D model and physically in the working environment. The robot travels towards the surface edge in the correct orientation relative to the surface and is ready to deploy and initiate processing the surface, which is selected for working.

6.4) The robot scans and acquires the 3D model of the selected working surface, extracts this surface for processing and applies a selected end effector operation to the extracted surface.

6.5) An App is a concatenation of Tasks. Therefore, once a first Task is completed, the robotic system verifies if another Task is registered for execution. If so, it rehearses the filtering of the model and processing it as described above. This registered sequence of Tasks proceeds until all Tasks are executed.

6.6) The App is done and the system is ready to load a new App for execution. Tasks 6.3), 6.4), 6.5) are repeatable until all tasks of the selected App are completed.

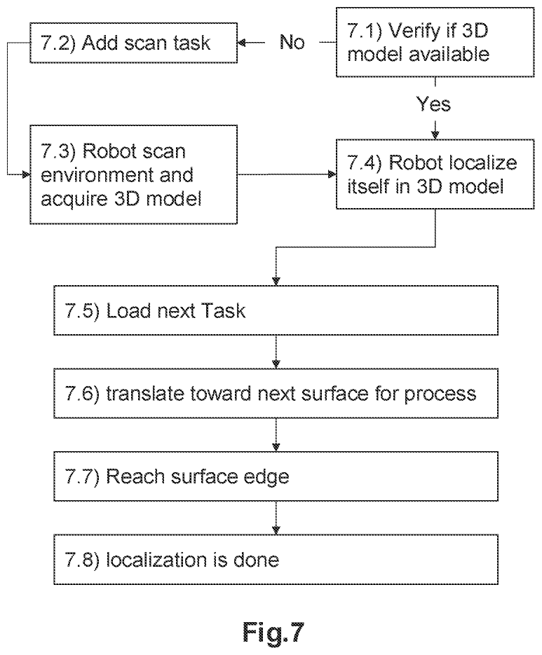

FIG. 7 illustrates flow of the task 6.3 of ‘Robot localizes itself’ of the autonomous robot. Several sequence flows are contemplated within the scope of step 6.3 for localizing the robot in a 3D model and the working environment. Selected such sequence flows are detailed below as follows with reference to FIG. 7:

7.1), 7.2), 7.3), 7.4), 7.5), 7.6), 7.7), 7.8) or

7.1), 7.4), 7.5), 7.6), 7.7), 7.8)

7.1) The PMA verifies if the App that was loaded is based on an available 3D model of the working environment or not.

7.2) If no model of the working environment is available, a task to scan the environment and acquire a model will be added. The scan of the ROI will be based on App ROI, which is defined by the App Tasks.

7.3) The robot scans the working environment and acquires a 3D model. The following is an embodiment example for such scan: The robot gets a snap shot from all its environment sensors and aligns all of them together to build a model. If the required ROI for scanning is larger relative to the snap shot from the environment sensors, the robot tries to scan extra areas of the environment in order to fill the missing data of the model. For example, by rotating in place, acquire more data of the environment and stitching and aligning it with a previous model acquired to fill holes in the model that might have not been acquired in the scan. Next, if needed, the robot moves towards the edge and holes of the acquired model and travels along the model contour edge while continuing the scan and stitching and aligning the new data acquired from the environment sensors. Once done, the model now has the area with the new edge contour. The robot repeats the process again of traveling along the new contour. This results with more and more information of the increased scanned area. This process continues until the robot cannot further enlarge its scan. Possible obstacles and reasons are objects that prevent it from traveling to fill holes in the model, and/or the robot is set to be confined to a specific ROI and the scanning of the entire ROI is completed, and/or the model is complete without any holes and nothing more left to be scanned. Other ways to scan the working environment are contemplated within the scope of the present invention. Non-limiting examples are using browning motion, S shape scan pattern, machine learning concept to let the system learn by itself how to acquire a 3D model of an environment, etc.

7.4) The robot requires localizing itself in the 3D model. If no model is available, the first location is aligned with the first acquisition, in which the robot localizes itself, setting its current location as the origin of coordinates. If the environment model is loaded from memory, the robot acquires a patch of the environment and aligns it with the model, which is retrieved from the memory (similar to assembling a puzzle). Once aligned, the rotation and translation required to align the acquisition part with the loaded model are used as transformation to localize the robot in the environment and later to correctly build the trajectories for the robot.

7.5) The app is built from concatenation of Tasks. Therefore it automatically loads the next available Task.

7.6) The robot filters the environment 3D model and extracts a surface model for processing. Then the PMA calculates a trajectory based on the unfiltered model to translate the robot towards the surface intended for processing. It takes into account obstacles and holes and avoids them to enable the robot to reach in front of the surface for processing without collisions. Also the PMA takes into account the parameters of the end tool for process and robot dimensions to align the robot correctly to arrive in front of the surface at a correct orientation which is required for processing.

7.7) The PMA verifies if the robot is near the edge of the surface in front of it. For example, the PMA verifies the relative position of the robot to the surface by identifying an edge to the right of the robot, and/or an obstacle located for example to the right of the robot and prevents it from moving to the right along the surface, and/or the robot is located at the edge of allowed ROI.

If the PMA finds that the robot is not near an edge of the surface, it generates a trajectory and execution motion. Such trajectory may be to the right along the surface intended for processing while traveling and simultaneously acquiring data from the environment sensors. At the same time, the PMA filters the data to keep track of the surface and uses the acquired unfiltered data to verify that no obstacles prevent the robot from traveling to the right of the surface. The PMA uses the acquired unfiltered data to keep the continuous movement of the robot. The surface does not have to be flat, and the PMA builds a translation trajectory to keep traveling alongside the surface till finding the surface edge or an obstacle that prevents the robot from traveling to the right or reaching the edge of the allowed ROI. Otherwise, the system returns to the starting point of the search of the edge, for example in a room with curved walls, e.g., cylindrical, oval, round.

7.8) The robot is localized and ready to start scanning and processing the desired surface.

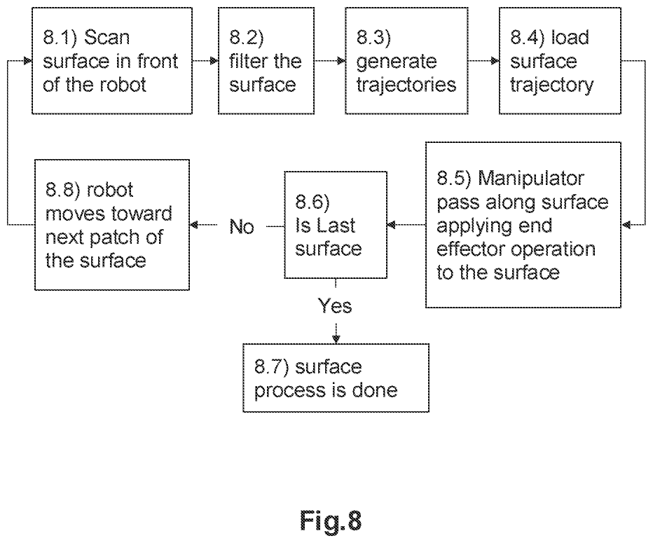

FIG. 8 illustrates flow for operating the end effector for a particular processing of a selected surface. The flow essentially comprises the operations of task 6.4: ‘Scan surface, extract trajectory and apply end effector operation to the surface’ of the autonomous robot. The flow is as follows:

8.1), 8.2), 8.3), 8.4), 8.5), 8.6), 8.8).

This flow repeats itself until the end effector processes the entire surface. Then the robot continues to final step 8.7). The following details the actions taken in each step.

8.1) The robot scans all environment data it can obtain from the surface in front of it. This scan can be part of the entire surface for processing (Surface Patch), for a large surface relative to the robot manipulator reaching zone. Otherwise, it can be the entire surface intended for processing.

8.2) According to the Task, the Surface Patch is filtered and the surface for processing is extracted.

8.3) The Path Generator receives the environment model, Filtered Model, Task settings and transformation matrix that localizes the robot in the 3D model, and generates trajectories to process the filtered Surface Patch.

8.4) The PMA loads the surface model and processes commands ready to be sent to the robot.

8.5) The PMA starts to send commands for execution to the robot. During execution, the PMA monitors the execution, verifying the correct execution according to the Task and end effector settings. After all the commands are sent and executed, the outcome is a manipulator that passes along the filtered Surface Patch with its end effector.

8.6) The PMA verifies if a further surface should be processed. For example, it compares the actual surface which has just been processed to the entire surface for processing according to the model.

8.7) Task is done.

8.8) The PMA sends commands to the robot to move, for example to the left of the last actual processed width of the filtered Surface Patch. It travels a distance along the surface monitoring robot location and orientation relative to the surface and environment model and corrects commands during movement and processing until reaching the next patch at the correct orientation, so the next surface patch is in front of the robot and ready to be processed.

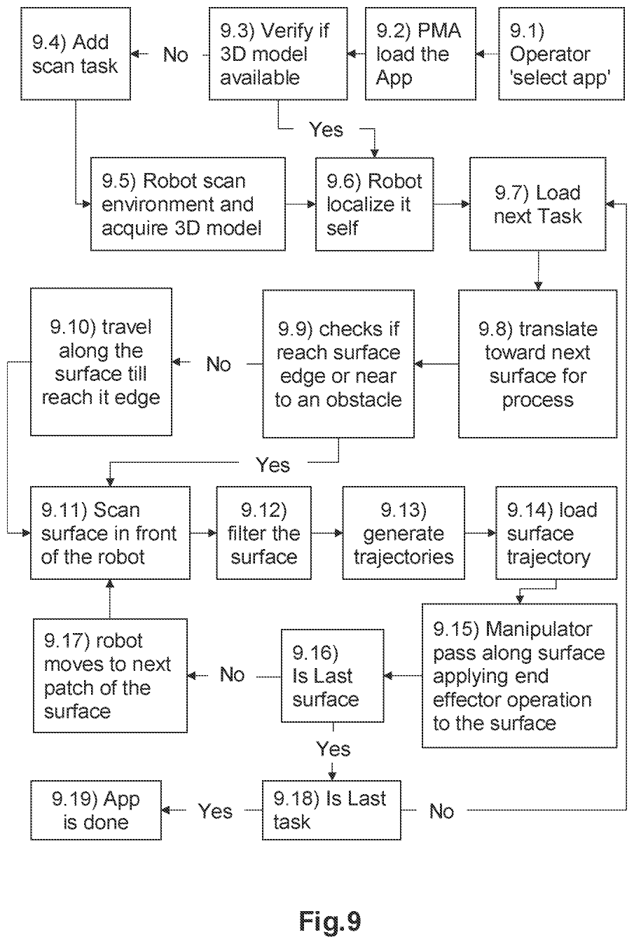

FIG. 9 illustrates a particular example of flow of the autonomous robotic system. As shown, several flows detailed below are available to complete all the Tasks of the App according to certain conditions:

9.1), 9.2), 9.3), 9.4), 9.5), 9.6), 9.7), 9.8), 9.9), 9.10), 9.11), 9.12), 9.13), 9.14), 9.15); 9.16), 9.17), 9.11), 9.12), 9.13), 9.14), 9.15), 9.16),9.18), 9.19);

9.1), 9.2), 9.3), 9.4), 9.5), 9.6), 9.7), 9.8), 9.9), 9.11), 9.12), 9.13), 9.14), 9.15), 9.16), 9.17), 9.11), 9.12), 9.13), 9.14), 9.15), 9.16),9.18), 9.19);

9.1), 9.2), 9.3), 9.6), 9.7), 9.8), 9.9), 9.10), 9.11), 9.12), 9.13), 9.14), 9.15), 9.16), 9.17), 9.11), 9.12), 9.13), 9.14), 9.15), 9.16),9.18), 9.19); 9.1), 9.2), 9.3), 9.6), 9.7), 9.8), 9.9), 9.11), 9.12), 9.13), 9.14), 9.15), 9.16), 9.17), 9.11),

9.12), 9.13), 9.14), 9.15), 9.16),9.18), 9.19).

Other flows are available in this diagram depending on the conditions onsite and in real-time and the Tasks that should be carried out and completed. Exemplary conditions may be the number of surface patches to be processed, obstacles and surface topography.

9.1) The operator selects an App for execution.

9.2) The PMA loads the selected App.

9.3) The PMA verifies if the App that was loaded is based on available 3D model of the environment or not.

9.4) In case that no model of the environment is available, a task to scan the environment and acquire a model will be add. The scan of the ROI will be based on App ROI, which is defined by the Apps Tasks.

9.5) The robot scans the environment and acquires a 3D model. The following is an embodiment example for such scan: The robot gets a snap from all its environment sensors and aligns all together to build a model. If the required ROI for scan is larger relative to the snap shot from the environment sensors, the robot attempts to scan additional areas of the environment to fill the missing data of the model. For example, by rotating in place, acquire more data of the environment and stitching and aligning it with a previous model acquired to fill gaps in the model that might have not been acquired in the scan. Next, if needed, it moves toward the edge and gaps of the acquired model and travels along the model contour edge while continuing the scan and stitching and aligning the new data acquired from the environment sensors. Once done, the model now has the area with the new edge contour. The robot repeats the process again of traveling along the new contour. This results with more and more information of the increased scanned area. This process continues until the robot cannot enlarge its scan, because there are objects that prevent it from traveling to fill gaps in the model, and/or the robot is set to be confined to a specific ROI and the scanning of the entire ROI is completed, and/or the model is complete without any gaps and nothing more left to be scanned. A person skilled in the relevant art can think of other ways to scan an environment, for example by using a browning motion, S shape scan pattern, machine learning concept to let the system learn by itself how to acquire a 3D model of an environment, etc.

9.6) The robot requires localizing itself in the 3D model. If no model is available, the first location is aligned with the first acquisition and the robot is localized, setting the current location as the origin of coordinates. If the environment model is loaded from memory, the robot acquires a patch of the environment and aligns it with the model from the memory (similar to assembling a puzzle). Once aligned, the rotation and translation required to align the acquisition part with the loaded model are used as transformation to localize the robot in the environment and later to correctly build the trajectories for the robot.

9.7) The app is built from concatenation of Tasks. Therefore, it automatically loads the next available Task.

9.8) The robot filters the environment 3D model and extract surface model for processing. Later, the PMA calculates a trajectory based on the unfiltered model to translate the robot towards the surface intended or registered for processing. It takes into account obstacles and pits, and avoids them to enable the robot to reach in front of the surface for processing without collisions. Also the PMA takes the parameters of the end tool into account for processing and robot dimensions to align the robot correctly and arrive in front of the surface at a correct orientation, which is required for processing.

9.9) The PMA verifies if the robot is near the edge of the surface, for example an edge to the right of the robot or if an obstacle is located for example to the right of the robot and prevents it from moving to the right along the surface.

9.10) The robot traveling, for example to the right, along the surface for processing, while simultaneously acquiring data from the environment sensors and filtering the data to keep track of the surface for processing and verifying in the unfiltered data acquired that no obstacles prevent the robot from traveling to the right of the surface. The surface does not have to be flat and the PMA builds a translating trajectory to keep traveling along the surface until finding the surface edge or an obstacle that prevents it from traveling to the right, or the system returns to a first location that the robot starts with to search for the edge (for example, a room with curved walls, e.g., cylindrical, oval, round).

9.11) The robot scans all the environment data it can acquire from the surface in front of it. This scan can most likely be part of the entire surface for processing (Surface Patch) for a large surface relative to the robot manipulator reaching zone. However, in some cases it can be the entire surface intended for processing.

9.12) According to the Task, the Surface Patch is filtered.

9.13) The Path Generator gets the environment model, Filtered Model, Task settings and transformation matrix that localizes the robot in the 3D model, and generates trajectories to process the filtered Surface Patch.

9.14) The PMA loads the surface model and processes commands ready to be sent to the robot.

9.15) The PMA starts to send commands for execution to the robot. During execution, the PMA monitors the execution, verifying the correct execution according to the Task and end tool settings. After all the commands are sent and executed, the outcome is a manipulator that passes along the filtered Surface Patch with its end effector.

9.16) The PMA verifies if a further surface should be processed. For example, it compares the actual surface that has been processed relative to the entire surface for processing in the model.

9.17) The PMA sends commands to the robot to move, for example to the left of the last actual processed width of the filtered Surface Patch. It travels a distance along the surface, monitoring the robot location and orientation relative to the surface and environment model. During this traveling it corrects commands during the movement process until reaching the next patch at the correct orientation so the next surface patch is in front of the robot and ready to be processed.

9.18) An App is a concatenation of Tasks. Therefore, once a first Task is completed, it verifies if another Task is available. If so, it starts over to filter the model and process it as described above. This chain of Tasks continues until all Tasks are executed.

9.19) The App is done and the system is ready to load a new App for execution.
In all the above steps, when an environment data is acquired, a large combined 3D environment model can be extracted by storing, aligning and stitching all or part of the data being acquired. This data can be stored and used later, for example in the next task or sent later or kept for the operation of another robot as the environment model or other way may allow in the relevant technical field.

The 3D filtered and the unfiltered model is used to generate a translation trajectory in space for the robotic assistant to reach every surface in the environment as defined in the filtered model. For every surface, a trajectory is generated for the manipulator to cover the entire surface taking into account the end effector parameters which are set in the task.

When the 3D model is uploaded from memory, the robotic assistant snaps a patch of the environment using its 3D sensors, and localizes itself relative to the model, which means that it registers itself in the model. Particularly, it enables the PMA to generate a correct trajectory for the robotic assistant to reach different places in space. Once localizes and if needed, all trajectories are updated.

Before translating between locations in space, the PMA sets the system to be in safe path to travel, if available. For example, the scaffold transforms to translation mode in order to prevent turning over while moving.

The robot begins to travel to a first surface. When reaching the surface, the PMA sets the robotic system to a deploy mode. For example, the scaffold system transforms and expands itself correctly and without collisions, since the environment 3D model is already acquired. When reaching the first surface the robot manipulator, namely the scaffold load, passes along the surface. During operation the robotic assistant senses the surface and environment including the end effector feedback if available, and can correct/improve its trajectory in real-time according to the feedback. A feedback can also be used to improve the environment model and for other purposes in real-time.

If the surface is large relative to the manipulator extension capacity without translation, then the PMA splits the surface to several segments. After completing a first segment, the system translates to the following one until completing the work in the entire surface. The robotic assistant can shift the manipulator inside the scaffold frame and/or by translating it entirely to enable the manipulator to reach any specific segment of the surface.

Once done, the robotic assistant moves to the next surface and repeats the process as detailed above.

After all surfaces are completed according to the task assigned to the ROI, the PMA loads the next Task and repeats the process described above, until all tasks are done. And when all the tasks are completed, then the App is done.

Several robotic chassis can work together in parallel or to support each other. For example one robotic chassis (robot1) can have a robotic arm as its manipulator with an end effector that works on compressed air. Another robotic chassis (robot2) can have a compressor as its load. The compressor of robot2 can be wired to robot1. Robot2 will then have trajectories similar to those of robot1 with an offset to prevent collisions. Similarly, two or more robots can work in parallel to increase yield/throughput. Another example is several robots that operate in an environment and having end effectors attached to them. Another robot travels in space as an end effector toolbox that arrives near any one of the robots and enables it to replace its end tool.

For multi-robot operation, an Ensemble Manager is available. The Ensemble Manager is a software (SW) that monitors all PMAs which are set to communicate with it. Every PMA has its own location in space and sends it to the Ensemble Manager. Similarly every PMA has its own environment model which is sent to the Ensemble Manager that aligns all models according to a single unified model, in which every PMA is located. This enables to supervise over several PMAs, and operate them together, where the PMAs support each other without collisions and with correct offset between the systems.

The End Effector can be located in space in a known position and the robot can approach and replace it autonomously or manually by an operator. The End Effector can have an ID with all its parameters, which enables the system to automatically get all the parameters without the help of the operator.

1. A robotic assistant comprising:
a scaffold;
a load carrier configured to be carried by said scaffold;
a manipulator configured to be carried on said load carrier;
an end effector mounted on said manipulator for carrying out a selected task;
sensors attached to said scaffold and configured to return sensing information of an environment of said robotic assistant; and
a PMA (Process Manager Apparatus) configured to support execution of a plurality of apps (applications) and tasks with said robotic assistant; and
a gravity leveler,
wherein said scaffold is foldable.

2. (canceled)

3. The robotic assistant according to claim 1, wherein said foldable scaffold comprises:
telescopic poles in vertical position relative to a gravity plane;
a chassis frame support surrounding said telescopic poles in horizontal position relative to said pole.

4.-10. (canceled)

11. The robotic assistant according to claim 1, wherein said chassis frame support comprises a plurality of frames surrounding said telescope poles wherein each one of said frames comprises a plurality of parts, wherein said parts are connected together in a telescopic configuration.

12.-14. (canceled)

15. The robotic assistant according to claim 3, wherein said gravity leveler is selected from a rack pinion concept, a telescopic level, a hydraulic piston a magnetic piston for leveling said scaffold relative to a reference gravity plane, wherein said gravity leveler is located at bottom of said telescopic poles and in mechanical communication with a bottom part of said poles, wherein each gravity leveler generates a total length of a corresponding telescopic pole that is different from total length of all other poles, wherein difference of length of said poles enables controlling orientation of said scaffold.

16. The robotic assistant according to claim 15, further comprising an orientation sensor on said scaffold, said sensor constantly sending feedback on actual orientation of said scaffold.

17. The robotic assistant according to claim 15, wherein leveling said scaffold with said gravity leveler is done continuously or on demand, wherein once triggered said leveling is done autonomously by said robotic assistant.

18. (canceled)

19. The robotic assistant according to claim 1, wherein said load carrier comprises two major parts parallel each other and connected to each other with a minor part between them in a telescopic configuration, wherein said load carrier is expandable, wherein said load carrier in fixedly connected to said scaffold.

20. (canceled)

21. The robotic assistant according to claim 1, wherein said load carrier comprises two major parts parallel each other and connected to each other with a minor part between them in a telescopic configuration, wherein said load carrier is expandable, wherein said load carrier is vertically movable along said scaffold.

22.-28. (canceled)

29. The robotic assistant according to claim 1, further comprising means for trans-locating said scaffold in and between working zones, wherein said scaffold further comprises one or more land mobility units connected to lower ends of telescopic poles of said scaffold, wherein said land mobility units expand and retract laterally together with expansion and retraction of said scaffold.

30. The robotic assistant according to claim 1, further comprising means for trans-locating said scaffold in and between working zones, wherein said scaffold further comprises one or more land mobility unit connected to lower ends of telescopic poles of said scaffold, wherein said land mobility units expand and retract laterally separately from said scaffold.

31. The robotic assistant according to claim 1, wherein said scaffold further comprises one or more aerial mobility unit connected to upper ends of telescopic poles of said scaffold.

32. The robotic assistant according to claim 31, wherein said aerial mobility units are integrated with said scaffold.

33. The robotic assistant according to claim 31, wherein said aerial mobility units are detachable off-the-shelf aerial vehicles.

34. The robotic assistant according to sis claim 31, wherein said aerial mobility unit is a UAV (Unmanned Aerial Vehicle).

35. The robotic assistant according to claim 31, wherein said telescopic poles of said scaffold are configured as gravity levelers, wherein each telescopic pole has a total length that is different from total length of all other poles, wherein difference of length of said poles enables controlling orientation of said scaffold.

36.-43. (canceled)

44. The robotic assistant according to claim 1, wherein said PMA comprises:
a UI (User Interface) comprising a GUI (Graphical User Interface) a power unit;
SW (Software) algorithms (Algos) for operating said robotic assistant;
at least one CPU (Central Processing Unit);
at least one control unit for controlling inputs and outputs, motor types, encoders, brakes and similar components of said robotic assistant;
at least one sensor configured to sense environment of said robotic assistant; and
an interface with devices of said robotic assistant, said devices comprising motors, sensors and communication devices.

45.-50. (canceled)

51. The robotic assistant according to claim 44, wherein said PMA is configured to control movement of said robotic assistant to position, getting status of motors operating in said robotic assistant, receiving encoders feedback and sensors feedback and allowed region of operation for said robotic assistant and obtaining values of parameters relating to ongoing operation of said robotic assistant in real-time in any working zone.

52. The robotic assistant according to claim 44, wherein said PMA is configured to completely control, operate and manage said scaffold, obtain readings of all said sensors, control motors operating expansion and retraction of poles of said scaffold, control status of said brakes, obtain data related to self-location of said scaffold in any particular environment, control height of carriage of said scaffold, keep said scaffold normal and parallel to gravity direction, change maximal allowed height of said scaffold and increase stability of said robotic assistant by folding and unfolding base of said scaffold.

53.-54. (canceled)

55. The robotic assistant according to claim 44, wherein said software algorithm of said PMA comprises filter blocks and path generator, wherein said filter blocks are software blocks for filtering data obtained from said sensors of said robotic assistant, receiving data from said filter blocks and generating a filtered surface, wherein said path generator is configured to generate a trajectory based on said filtered surface and end effector parameters.

56.-60. (canceled)

61. A method for creating a task with a robotic assistant comprising:
providing a robotic assistant comprising:
a scaffold;
a load carrier configured to be carried by said scaffold;
a manipulator configured to be carried on said local carrier;
an end effector mounted on said manipulator for carrying out a selected task;
sensors attached to said scaffold and configured to return sensing information of an environment of said robotic assistant; and
a PMA (Process Manager Apparatus) configured to support execution of a plurality of apps (applications) and tasks with said robotic assistant; and
a gravity leveler,
wherein said scaffold is foldable;
in a UI of said PMA, selecting to create a task;
defining work plane(s) and/or work space(s) for executing said task;
in the UI, setting edge conditions for executing said task;
setting an ROI (Range Of Interest) for said task; and
selecting an end effector for carrying out an application and setting parameters of said end effector for operation,
wherein said defining work plane(s) and/or work space(s) comprises: providing a three dimensional environment model mutable for said task,
wherein said defining work plane(s) and/or work space(s) comprises:
selecting sensors for scanning said environment;
selecting Filter Block(s) for filtering sensing data form said sensors; and
reiterating selection of sensors and concentrating another Filter Block(s) until completing construction of said Filter Blocks.

62.-78. (canceled)

79. A method for executing an app (application) with a robotic assistant said method comprising:
providing a robotic assistant comprising:
a scaffold;
a load carrier configured to be carried by said scaffold;
a manipulator configured to be carried on said local carrier;
an end effector mounted on said manipulator for carrying out a selected task;
sensors attached to said scaffold and configured to return sensing information of an environment of said robotic assistant; and
a PMA (Process Manager Apparatus) configured to support execution of a plurality of apps (applications) and tasks with said robotic assistant; and
a gravity leveler,
wherein said scaffold is foldable;
selecting an app stored in a data memory accessible for said robotic assistant;
loading said application with said PMA (Process Manager Apparatus);
localizing said robotic assistant in a 3D model of a working environment;
scanning a working surface or a first patch of a working surface;
initiating a first task comprising applying end effector to said working surface or first patch of a working surface;
completing said first task;
loading next task;
reiterating actions of localizing, scanning and applying an end effector for next task; and
completing execution of said app.

80.-91. (canceled)

92. A method for executing an application with a robotic assistant, said method comprising:
providing a robotic assistant comprising:
a scaffold;
a load carrier configured to be carried by said scaffold;
a manipulator configured to be carried on said local carrier;
an end effector mounted on said manipulator for carrying out a selected task;
sensors attached to said scaffold and configured to return sensing information of an environment of said robotic assistant; and
a PMA (Process Manager Apparatus) configured to support execution of a plurality of apps (applications) and tasks with said robotic assistant; and
a gravity leveler,
wherein said scaffold is foldable;
selecting an application stored in a data memory accessible for said robotic assistant;
loading said application with said PMA (Process Manager Apparatus);
providing a three dimensional environment model for said application;
localizing said robotic assistant in said three dimensional environment model;
concatenating a plurality of tasks to form and executed said application;
filtering said three dimensional environment model and selecting desired surfaces to process for every task;
activating a Path Generator, said Path Generator is provided with said model, filtered model, tasks settings and a transformation matrix for localizing said robotic assistant in said model and generating trajectories of motion for said robotic assistant for processing every selected surface;
sending command to said robotic assistant for reaching said surfaces in a selected order, monitoring commands for processing every surface and correcting movement of said robotic assistant during said processing;
loading model of a surface and processing command for execution by said robotic assistant;
monitoring and verifying correct execution with said PMA with said end effector, completing processing of said surface and reiterating said loading of model, monitoring and verifying correctness of execution for another surface;
completing a task and reiterating processing of another task in sequence; and
completing entire concatenation of said tasks.

93.-103. (canceled)
